(19) United States
(12) Patent Application Publication
(10) Pub. No.: US 2023/0001599 A1
(43) Pub. Date: Jan. 5, 2023

(54) Matless Cutting Machine and Methods

(71) Applicant: Cricut, Inc., South Jordan, UT (US)

(72) Inventors: Jeremy Burton CRYSTAL, Springville, UT (US); John Barrus CHRISTENSEN, Bluffdale, UT (US); Marc KORBULY, Salt Lake Ciry, UT (US); Bryan Fred BIHLMAIER, Provo, UT (US); Donald Christopher SUTTON, South Jordan, UT (US); Danielle CORDSEN, South Jordan, UT (US)

(73) Assignee: Cricut, Inc., South Jordan, UT (US)

(21) Appl. No.: 17/757,086

(22) PCT Filed: Dec. 11, 2020
(86) PCT No.: PCT/US2020/064534

§ 371 Date: Jun. 9, 2022

Related U.S. Application Data
(60) Provisional application No. 62/947,473, filed on Dec. 12, 2019.

(51) Int. Cl. B26D 7/01; B26D 3/08; B26D 7/06; B26D 7/20

(52) U.S. Cl. CPC B26D 7/015; B26D 3/08; B26D 7/06; B26D 7/20; B26F 1/3813

(57) ABSTRACT

An electronic cutting machine includes a working surface, a door, and a first material guide. The working surface is configured to support a workpiece. The door is movable between an open position and a closed position and includes an upper surface configured to support the workpiece in the open position. The upper surface is disposed substantially parallel to the working surface. The first material guide extends from the upper surface when the door is in the open position.

### CROSS-REFERENCE TO RELATED APPLICATIONS

This application claims priority under 35 U.S.C. § 119(e) to U.S. Patent Application No. 62/947,473, filed on Dec. 12, 2019, the disclosure of which is considered part of the disclosure of this application and is hereby incorporated by reference in its entirety.

### TECHNICAL FIELD

The present disclosure relates generally to electronic cutting systems, methods, and apparatus. In particular, the present disclosure relates to matless cutting machines.

### BACKGROUND

This section provides background information related to the present disclosure and is not necessarily prior art.

Throughout history, individuals have found a sense of personal fulfillment, achievement, satisfaction, and expression by creating art. In recent times, during the late 19^{th} century, an art reform & social movement led by skilled tradesmen was slowly starting to be recognized by many people across America, Canada, Great Britain and Australia. This movement has often been referred to as the “arts-and-crafts movement.”

The so-called arts-and-crafts movement that began many years ago has continued to evolve today by many persons that may not necessarily be skilled in a particular trade. As such, it may be said that non-skilled persons may be involved in the arts-and-crafts as a social activity or hobby. In some circumstances, the activity or hobby may be practiced for any number of reasons ranging from, for example: economic gain, gifting, or simply to pass time while finding a sense of personal fulfillment, achievement, satisfaction, and expression.

With advances in modern technology, the “arts-and-Crafts Movement” that began many years ago is susceptible to further advancements that may enhance or improve, for example, the way a skilled or non-skilled person may contribute to arts-and-crafts. Therefore, a need exists for the development of improved components, devices and the like that advance the art.

One category of devices being developed and improved are electronic cutting machines, which may also be referred to as vinyl cutters, X-Y plotter cutters, or simply cutters in general. Currently available electronic cutting machines of the prior art fall short in a number of aspects affecting user experience and enjoyment.

For example, cutting machines of the prior art are typically configured to cut only a limited amount of material at a time. Most home-use cutting machines have a limited working area and require the use of relatively rigid cutting mats. Typically, a material to be cut is placed on the cutting mat and the mat is fed into the machine. The machine manipulates the cutting mat, rather than the material itself, and a tool, such as a cutting blade, impinges downward onto the material. In these machines, the cutting blade may cut through the material while the tougher cutting mat prevents the blade from penetrating the mat itself.

Cutting mats are typically more rigid and thicker than materials being cut, such as vinyl, iron-on materials, fabric, and paper/cardstock, and are thus easier to keep aligned while moving back and forth through the cutting machine during a project. When a user wants to cut a material, such as vinyl, the user puts the vinyl onto the cutting mat and then loads the mat into the cutting machine. The machine aligns the cutting mat, and thus the vinyl on the cutting mat, when cutting the vinyl during use.

However, cutting mats are inherently limited in length because they are typically too thick and rigid to roll-up for shipping or storage, thus taking up too much space. Cutting mats are also more expensive than vinyl and paper materials being cut, due to the more robust construction and materials of the cutting mats. Thus, it is cost prohibitive to make and sell lengthy cutting mats.

There are materials, such as vinyl or paper materials, which include backer layers that enable matless cutting within some electronic cutting machines. However, these materials are thinner and more flexible by nature, so a user repeatedly pauses the machine, releases the material, realigns the material by hand, and re-secures the material prior to cutting.

Accordingly, there are a number of disadvantages in the art that can be addressed.

### SUMMARY

This section provides a general summary of the disclosure, and is not a comprehensive disclosure of its full scope or all of its features.

Embodiments of the present disclosure relate generally to electronic cutting systems, methods, and apparatus. In particular, the present disclosure relates to matless cutting machines. For example, in one embodiment of the present disclosure, a matless cutting machine includes: a working surface configured to support a material sheet fed into the cutting machine during use; a door; and one or more sets of material guides extending upward from the working surface. In such an embodiment, at least one set of the one or more sets of material guides extend upward from an upper surface of the door when the door is open, the upper surface of the open door forming at least a portion of the working surface.

In one embodiment of the present disclosure, a matless cutting machine includes a roller system having a first roller and an opposing second roller, the upper and lower rollers biased together via a biasing force. In such an embodiment, the first roller comprises a material having a coefficient of static friction of less than 1.

In one embodiment of the present disclosure, a matless cutting machine includes: a working surface disposed in a horizontal X-Y plane, the working surface configured to support a material sheet fed into the cutting machine during use; and a material sensing mechanism. In such an embodiment, the material sensing mechanism includes a rocker arm disposed in the X-Z plane perpendicular to the X-Y plane in which the working surface is disposed.

In one embodiment of the present disclosure, a matless cutting machine includes: a material sheet having an upper layer and a lower backing layer; and an electronic cutting machine configured to automatically align and maintain alignment of the material sheet as the material sheet is fed through the cutting machine during use.

One aspect of the disclosure provides an electronic cutting machine. The electronic cutting machine may include a working surface, a door, and a first material guide. The working surface may be configured to support a workpiece. The door may be movable between an open position and a closed position. The door may include an upper surface configured to support the workpiece in the open position. The upper surface may be disposed substantially parallel to the working surface. The first material guide may extend from the upper surface when the door is in the open position.

Implementations of this aspect of the disclosure may include one or more of the following optional features. In some implementations, the electronic cutting machine includes a second material guide and a tool. The second material guide may extend from the working surface. The tool may be coupled to the electronic cutting machine and disposed between the first material guide and the second material guide.

In some implementations, the electronic cutting machine includes a third material guide extending from one of the working surface or the upper surface.

In some implementations, the electronic cutting machine includes a second material guide and a third material guide. The second material guide may extend from the working surface. The first material guide and the second material guide may collectively defining a total length in a Y-direction. The third material guide may extend from one of the working surface or the upper surface. The third material guide may be spaced from the first material guide or the second material guide by a distance in an X-direction. The total length may be at least 30% of the distance. In some implementations, the total length is at least 40% of the distance.

Another aspect of the disclosure provides an electronic cutting machine. The electronic cutting machine may include a first roller and a second roller. The first roller may include an outer surface formed at least in part from a material having an average coefficient of static friction of less than one. The second roller may oppose the first roller. At least one of the first roller or the second roller may be biased toward the other of the first roller or the second roller by a force.

Implementations of this other aspect of the disclosure may include one or more of the following optional features. In some implementations, the second roller comprises a textured surface including a plurality of protrusions.

In some implementations, the force is greater than about 10 k g-f.

In some implementations, the material includes a polycarbonate having an average coefficient of static friction of between about 0.05 and 0.50.

In some implementations, the force is between about 10 kg-f and 14 kg-f.

Yet another aspect of the disclosure provides an electronic cutting machine. The electronic cutting machine may include a working surface and a rocker arm. The working surface may be disposed in a first plane and configured to support a workpiece. The rocker arm may be disposed in a second plane disposed transverse to the first plane. The rocker arm may be configured to pivot about an axis extending substantially parallel to the first plane.

Implementations of this other aspect of the disclosure may include one or more of the following optional features. In some implementations, the electronic cutting machine includes a material guide extending from the working surface in a direction transverse to the first plane and the second plane. The material guide may include an upper wall disposed at least partially above the rocker arm and extending in a third plane disposed substantially parallel to the first plane. The electronic cutting machine may include a rib extending downward from a lower surface of the upper wall.

A further aspect of the disclosure provides an electronic cutting machine kit. The electronic cutting machine kit may include a workpiece and an electronic cutting machine. The workpiece may include a workpiece material and a workpiece support material. The electronic cutting machine may be configured to receive the workpiece. The electronic cutting machine may include a plurality of guides configured to engage the workpiece support material and align the workpiece relative to the electronic cutting machine.

Implementations of this further aspect of the disclosure may include one or more of the following optional features. In some implementations, the workpiece support material forms a lower backing layer of the workpiece and defines a first width. The workpiece material may form an upper layer of the workpiece and define a second width that is less than the first width.

In some implementations, the workpiece support material is at least 35% of a total thickness of the workpiece.

In some implementations, guides are configured to align the workpiece without the use of a cutting mat.

In some implementations, the workpiece support material comprises a first layer of material, a second layer of material, and an adhesive material securing the first layer of material to the second layer of material.

In some implementations, the workpiece forms a non-plastically deformed roll.

Yet another aspect of the disclosure provides a method. The method may include receiving a workpiece into an electronic cutting machine. The workpiece may include a workpiece support material and a workpiece material. The workpiece support material may form a backing layer and define a first width. The workpiece material may form an upper layer and define a second width that is less than the first width. The method may include engaging the workpiece support material with at least one guide and at least one roller of the electronic cutting machine. The method may further include altering the workpiece material with the electronic cutting machine.

In some implementations, the at least one guide and the at least one roller are spaced apart from the workpiece material.

In some implementations, engaging the workpiece support material with at least one roller includes engaging the workpiece support material with (i) a first roller disposed on a first side of the workpiece support material and (ii) a second roller disposed on a second side of the workpiece support material. The first roller may be spaced apart from the second roller by a first distance that is greater than the second width.

A further aspect of the disclosure provides a workpiece. The workpiece may include a workpiece support material, a workpiece material, and an adhesive. The workpiece support material may form a backing layer and define a first width and a first thickness. The workpiece material may form an upper layer and define a second width and a second thickness. The second width may be less than the first width. The second thickness may be not more than 50% of the first thickness. The adhesive may secure the workpiece material to the workpiece support material.

The details of one or more implementations of the disclosure are set forth in the accompanying drawings and the description below. Other aspects, features, and advantages will be apparent from the description and drawings, and from the claims.

Each of the above independent implementations of the present disclosure, and those implementations described in the detailed description below, may include any of the features, options, and possibilities set out in the present disclosure and figures, including those under the other independent implementations, and may also include any combination of any of the features, options, and possibilities set out in the present disclosure and figures.

Additional features and advantages of exemplary implementations of the disclosure will be set forth in the description which follows, and in part will be obvious from the description, or may be learned by the practice of such exemplary embodiments. The features and advantages of such implementations may be realized and obtained by means of the instruments and combinations particularly pointed out in the appended claims. These and other features will become more fully apparent from the following description and appended claims or may be learned by the practice of such exemplary implementations as set forth hereinafter.

### DESCRIPTION OF DRAWINGS

In order to describe the manner in which the above-recited and other advantages and features of the present disclosure can be obtained, a more particular description of the disclosure briefly described above will be rendered by reference to specific configurations thereof which are illustrated in the appended drawings. Understanding that these drawings depict only typical configurations of the present disclosure and are not therefore to be considered to be limiting of its scope, the present disclosure will be described and explained with additional specificity and detail through the use of the accompanying drawings in which:

FIG. 1 is a front perspective view of a cutting machine with an open door to receive material, according to the principles of the present disclosure.

FIG. 2 is a rear perspective view of the cutting machine of FIG. 1.

FIG. 3 is an enlarged view of a portion of the cutting machine of FIG. 1, the enlarged view highlighting material guides located on an upper surface of the open door, according to the present disclosure.

FIG. 4 is a close-up view of a portion of the cutting machine of FIG. 1, the close-up view highlighting various material guides within the cutting machine, according to the present disclosure.

FIG. 5 is a top view of the cutting machine of FIG. 1.

FIG. 6 is an enlarged view of a portion of a roller system of a cutting machine, according to the principles of the present disclosure.

FIG. 7 is a perspective view of a lower roller of a cutting machine, according to the principles of the present disclosure.

FIG. 8A is a perspective view of a material suited for cutting by a cutting machine, according to the principles of the present disclosure.

FIG. 8B is a cross-sectional view of the material of FIG. 8A taken along the line 8B-8B.

FIG. 9 is a cross-sectional view of the material of FIG. 8B according to line 9/10 of FIG. 8B.

FIG. 10 is a cross-sectional view of the material according to line 9/10 of FIG. 8B.

FIG. 11 is an enlarged view of a portion of the cutting machine of FIG. 1, according to the principles of the present disclosure.

FIG. 12 is an enlarged view of a portion of the cutting machine of FIG. 1, according to the principles of the present disclosure.

FIG. 13 is a perspective view of a material roll holder for use with a cutting machine, according to the principles of the present disclosure.

FIG. 14 is a perspective view of a first step of using a system including a cutting machine to perform work on a workpiece, according to the principles of the present disclosure.

FIG. 15 is a perspective view of a second step of using the system according to FIG. 14.

FIG. 16 is a perspective view of a third step of using the system according to FIG. 14.

FIG. 16A is a cross-sectional view according to line 16A-16A of FIG. 16.

FIG. 16B is an enlarged view according to line 16B of FIG. 16.

FIG. 17 is a perspective view of a fourth step of using the system according to FIG. 14.

FIG. 17A is a cross-sectional view according to line 17A-17A of FIG. 17.

Corresponding reference numerals indicate corresponding parts throughout the drawings.

### DETAILED DESCRIPTION

The present disclosure relates generally to electronic cutting systems, methods, and apparatus. In particular, the present disclosure relates to matless cutting machines and provides technical solutions to a number of technical problems in the art discussed above.

For example, in one aspect of the matless cutting machines disclosed herein, the machines are configured to receive a material to be cut and to feed that material back and forth through the cutting machine without placing the material on a cutting mat.

In addition, in one aspect of the cutting machines disclosed herein, the cutting machines automatically align the material being cut without the user manually releasing the material and aligning or realigning the material before and/or during a project. Again, the disclosed cutting machines may do so without the use of more rigid cutting mats.

Because cutting machines of the present disclosure do not require cutting mats, one aspect of the cutting machines described herein allow for an unlimited length of material to be cut. That is, because the cutting machines described herein do not require the use of cutting mats, the cutting machines are not restricted to cutting only the area provided by a cutting mat. Rather, matless materials of theoretically indefinite length can be fed into the cutting machines and continuously cut while maintaining automatic alignment throughout the project.

In general, there are four categories of features of cutting machines and materials used with matless cutting machines, as disclosed herein, that enable effective, easy-to-use, automatic alignment of an unlimited length of material without the use of cutting mats. These features allow an unlimited length of material to be fed into a self-aligning cutting machine without the need for cutting mats or manual alignment of material being cut by the user. These four general categories of features include: 1) physical material alignment features of cutting machines; 2) materials and geometries of certain roller system components, including upper and lower rollers, within cutting machines; 3) roller system pinch pressures; and 4) matless material construction and configuration. There are also other categories of features beyond these four listed, as disclosed herein, that enhance the functionality and user interface experience with matless cutting machines.

One will appreciate, from the present disclosure, that any of the four categories of matless cutting features noted above and further described below may be employed individually, collectively, or in combination with any one or more other category of features, to enhance the matless cutting capabilities of an electronic cutting machine. As such, while some features may be described individually herein, any of the disclosed features and embodiments of matless cutting machines described may be combined with one or more other features or embodiments.

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

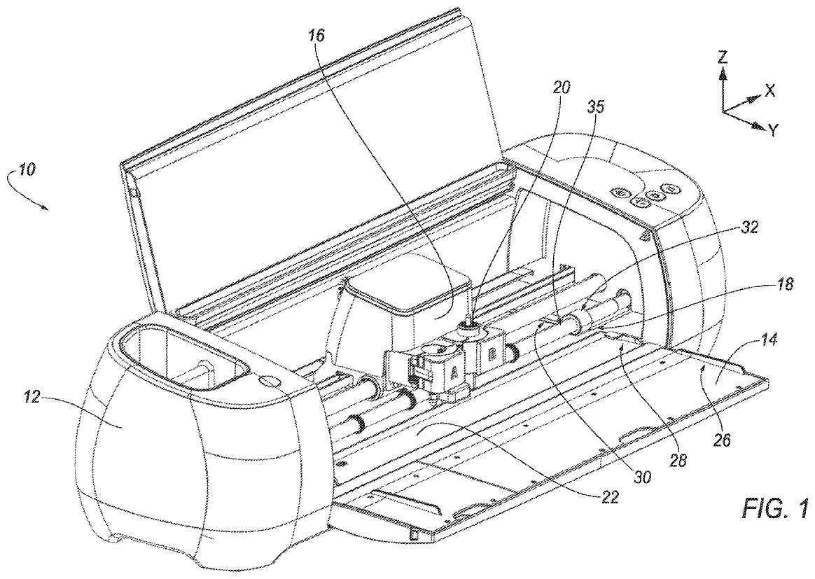

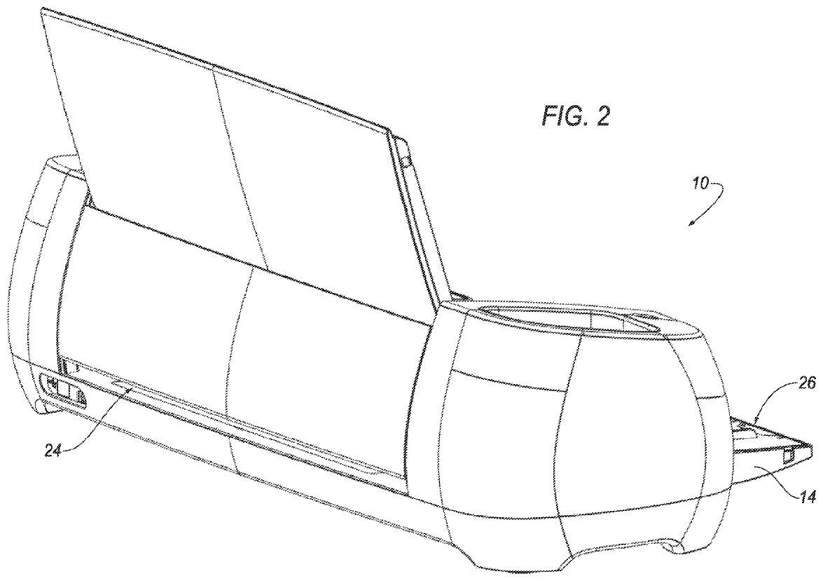

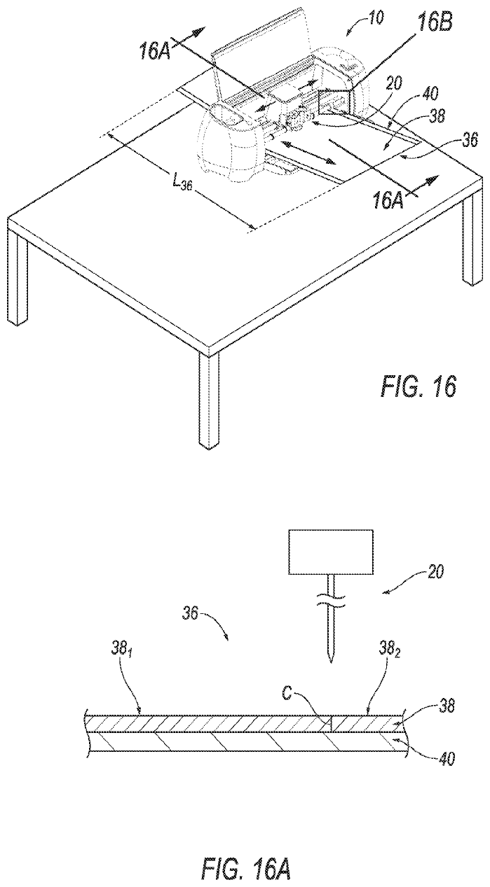

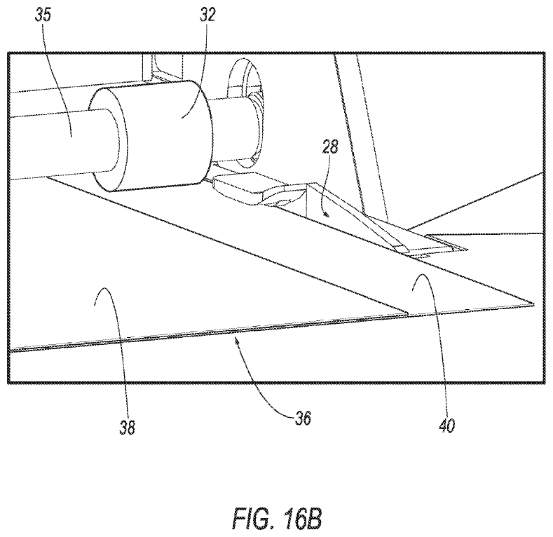

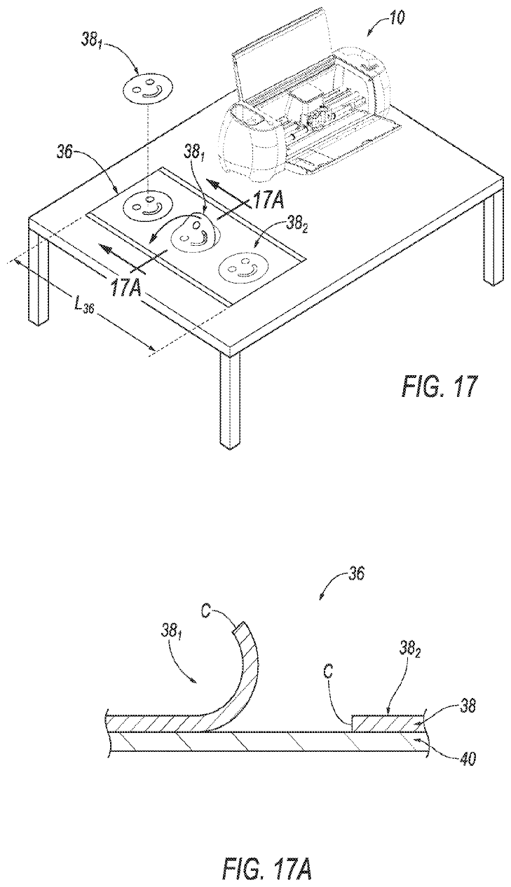

With reference to FIGS. 1-2, implementations of the present disclosure relate generally to an exemplary “matless” cutting machine 10, components thereof, and methods of use. Although the term “matless” infers that the cutting machine 10 may operate without conventional cutting mats, which are very rigid, the cutting machine 10 is uniquely configured to operate with a non-conventional workpiece support material that is a component of a non-conventional workpiece (see, e.g., FIGS. 8A, 8B, 9, and 10 illustrating a workpiece 36 including an upper layer 38 defining a workpiece material and a lower layer 40 defining a workpiece support material) that is non-rigid, flexible, rollable, or the like. Accordingly, the term “matless” can be construed to mean and be defined as including the workpiece support material layer 40 that is non-rigid, flexible, rollable, or the like. In other instances, the term “matless” should be construed to mean and be defined as a workpiece support material layer 40 that is “consumable” in the context that the workpiece 36 (that also includes the workpiece material layer 38 that is removably-secured to the workpiece support material layer 40) may be deformed (e.g., cut C as illustrated in FIG. 16A) after being interfaced with the cutting machine 10. Accordingly, as seen at FIGS. 17 and 17A, after the workpiece material 38 is cut C, a first portion 381 of the workpiece material layer 38 may be subsequently removed from the workpiece support material layer 40 while a second portion 382 of the workpiece material layer 38 remains removably-secured to the workpiece support material layer 40. As such, the workpiece support material layer 40 that forms a portion of the workpiece 36 may be configured for single use and disposal thereafter.

As seen at FIG. 1 the cutting machine 10 includes an outer housing 12 and a door 14. The door 14 is may be arranged in an open configuration to allow material to be inserted into the cutting machine 10. The door 14 may be selectively opened and closed via a hinge mechanism where door 14 connects to the outer housing 12. With reference to FIGS. 1-5, the door 14 is shown arranged in an open configuration in order to illustrate a plurality of internal cutting components of the cutting machine 10. The plurality of internal cutting components may include, but are not limited to, a carriage 16, a roller assembly 18, and other components that will be described in more detail below with reference to other figures.

When the door 14 is arranged in an open configuration, the workpiece 36, which is fed into cutting machine 10, may be at least partially supported on a working surface 22 of the cutting machine 10. The combination of the workpiece material layer 38 and the workpiece support material layer 40 is hereinafter collectively referred to as a workpiece 36. Thereafter, a tool 20 (e.g., a cutting blade) is configured to impinge into the workpiece 36 (see, e.g., the workpiece material layer 38 of the workpiece 36 at FIGS. 8A, 8B, 9, and 10). In some instances, an upwardly-facing surface of the door 14 (when arranged in an open configuration) may also at least partially define a portion of the working surface 22 that supports the workpiece 36 that is fed into and through the cutting machine 10. In this regard, in some implementations, the upper surface of the door 14 is substantially parallel (e.g., +/−10 degrees) to the working surface 22. In some implementations, the upper surface of the door 14 is substantially coplanar with the working surface 22. Additionally, or alternatively, in at least one embodiment, the cutting machine 10 may not include a door, but, rather, the working surface 22 may be otherwise extendable (e.g., in a telescoping arrangement) in order to increase the surface area of working surface 22.

As the workpiece 36 is fed forward-and-backward by the roller assembly 18, the carriage 16 manipulates the tool 20 for selectively impinging downwardly onto the workpiece material layer 38 of the workpiece 36. The carriage 16 can also move back-and-forth across the workpiece 36 in order to form cuts in any region of the workpiece material layer 38. Although the Figures illustrate the tool 20 including a cutting blade, the tool 20 being defined by a cutting blade is for exemplary purposes only, and, as such, one skilled in the art will appreciate that other tools (e.g., a scoring tool, an ink pen, or the like) may alternatively be secured and manipulated by the carriage 16.

The roller assembly 18 is said to move the workpiece 36 forward-and-backward in a Y-direction as the carriage 16 moves back-and-forth in an X-direction, as indicated by a reference coordinate system seen at FIG. 1. As noted above, the carriage 16 houses the tool 20; the tool 20 can be manipulated up-and-down vertically (i.e., a Z-direction) relative to the workpiece 36.

A rear, top, left perspective view of cutting machine 10 is seen at FIG. 2; in this view, a rear side of the outer housing 12 forms a pass-through slot 24 that allows the workpiece 36 to pass through cutting machine 10 without limiting the length of workpiece 36 being interfaced with the cutting machine 10. During operation, the workpiece 36 may pass into and out of the pass-through slot 24 as needed depending on, for example, one or both of: (1) the length of workpiece 36; and (2) the pattern being cut into the workpiece material layer 38. Thus, exemplary embodiments of the cutting machine 10 described here may include internal cutting components and other operating components such as, for example, motors, gears, belts, and other electronics, arranged so as to not interfere with the workpiece 36 passing all the way through the cutting machine 10 and through pass-through slot 24 during use.

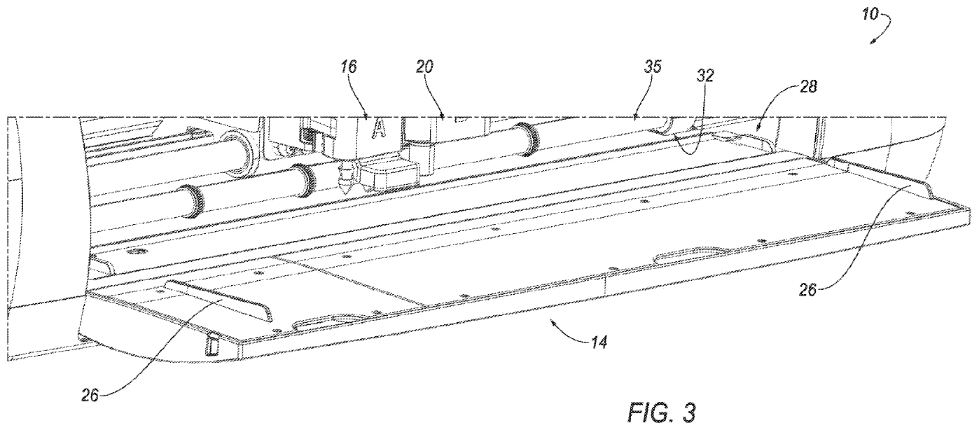

FIG. 3 illustrates a close-up view of an exemplary implementation of the matless cutting machine with the door 14 arranged in an open configuration whereby a first pair of workpiece guides 26 are shown extending away from the upwardly-facing surface of the door 14. In some instances, the first pair of workpiece guides 26 may define upwardly extending walls oriented longitudinally in the Y-direction. Furthermore, the first pair of workpiece guides 26 may vary in height, length, and shape, so long as the first pair of workpiece guides 26 do not interfere with other components of the cutting machine 10 when the door 14 is arranged in either of the open configuration or the closed configuration.

Yet even further, the lateral distance in the X-direction between the first pair of workpiece guides 26 is not limited to the arrangement seen at FIG. 3. Accordingly, the first pair of workpiece guides 26 may be fixedly configured in a number of predetermined lateral distances or dynamically selectively spaced apart to a desired lateral distance in order to accommodate a variety materials having different widths that may be interfaced with the cutting machine 10 by being arranged over or upon the working surface 22. As will be described in the following disclosure at FIGS. 8A, 8B, 9, and 10, various embodiments of workpiece support material layers 40 defining the workpiece 36 may be fed into the cutting machine 10 may be constrained laterally in the X-direction by the first pair of workpiece guides 26 as the roller assembly 18 feeds the workpiece 36 forward-and-backward in the Y-direction.

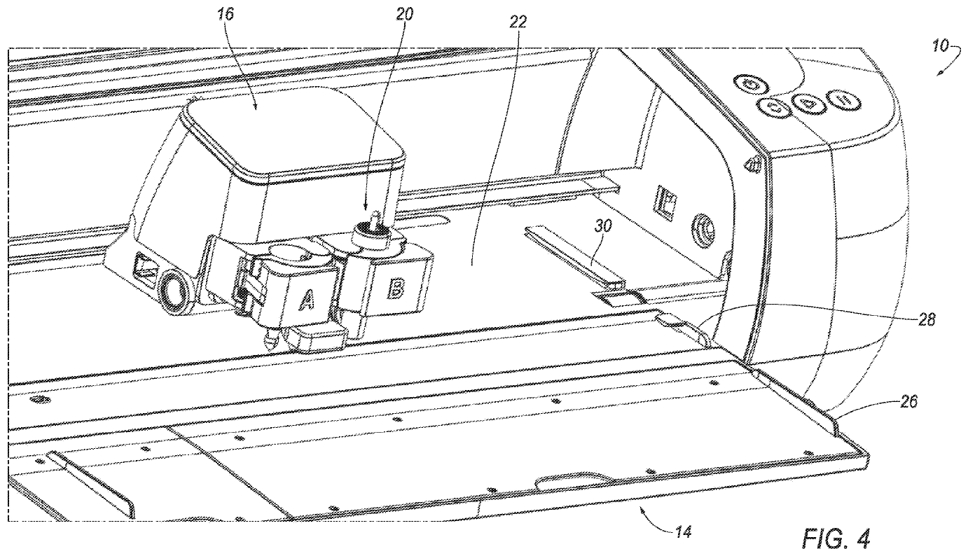

In addition to the first pair of workpiece guides 26 that are disposed on or extend away from the inner surface of the door 14, with reference to FIG. 4, the cutting machine 10 may also include one or both of an optional second pair of workpiece guides 28 and an optional third pair of workpiece guides 30. Each of the second pair of workpiece guides 28 and the third pair of workpiece guides 30 do not extend from or are disposed on the inner surface of the door 14, but, rather, are disposed on or extend from the working surface 22 of the cutting machine 10 and may be spaced apart at a lateral distance in the X-direction in a substantially similar manner as that of the first pair of workpiece guides 26. The view of FIG. 4 represents an exemplary close-up view of only one side of working surface 22 for illustrative purposes with various guide bars and belts of cutting machine 10 being removed in order to show an unobstructed view of the first, second, and third pairs of workpiece guides 26, 28, 30.

As shown, the second pair of workpiece guides 28 and the third pair of workpiece guides 30 are aligned longitudinally in the Y-direction with the first pair of workpiece guides 26 in order to accommodate the same width of a workpiece 36 that is fed into cutting machine 10. Each of the first paid of workpiece guides 26, the second set of workpiece guides 28, and the third set of workpiece guides 30 prevent a workpiece 36 from being fed into the cutting machine 10 from travelling too much laterally in the X-direction as the workpiece 36 is fed through cutting machine 10 forward-and-backward in the Y-direction by the roller assembly 18. In effect, the first pair of workpiece guides 26, the second paid of workpiece guides 28, and the third pair of workpiece guides 30 act as bumpers that contact the side edges of the workpiece 36 that are arranged upon or over the working surface 22.

Accordingly, if a user (not shown) feeds the workpiece 36 into the cutting machine 10 in a misaligned orientation longitudinally in the Y-direction (or, furthermore, in some instances in a further rotated/skewed direction about the Z-axis), the first pair of workpiece guides 26, the second pair of workpiece guides 28, and the third pair of workpiece guides 30 push against the side edges of the workpiece 36 in order to align the workpiece 36 as it is fed into cutting machine 10 through the roller assembly 18. Yet even further, if the workpiece 36 becomes misaligned during an ongoing project or during a cutting procedure, either due to the cutting machine 10 getting bumped or by way of the application of an external force that may knock or jar the workpiece 36 out of alignment, one or more of the first pair of workpiece guides 26, the second pair of workpiece guides 28, and the third pair of workpiece guides 30 protect the workpiece 36 from becoming misaligned, and, as a result, function in a manner that will automatically guide the workpiece 36 back into alignment. Accordingly, one or more of the first pair of workpiece guides 26, the second pair of workpiece guides 28, and the third pair of workpiece guides 30 automatically align and maintain alignment of the workpiece 36 that is fed into the cutting machine 10 during the initial feeding of the workpiece 36 into the cutting machine 10 that may occur, for example, during ongoing projects or during a cutting operation. As such, the function of automatic alignment of a workpiece 36 is effective without the user manually noticing a misalignment of the workpiece 36 and thereafter manually adjusting or successively readjusting the workpiece 36 before use of the cutting machine 10 or during use of the matless cutting machine.

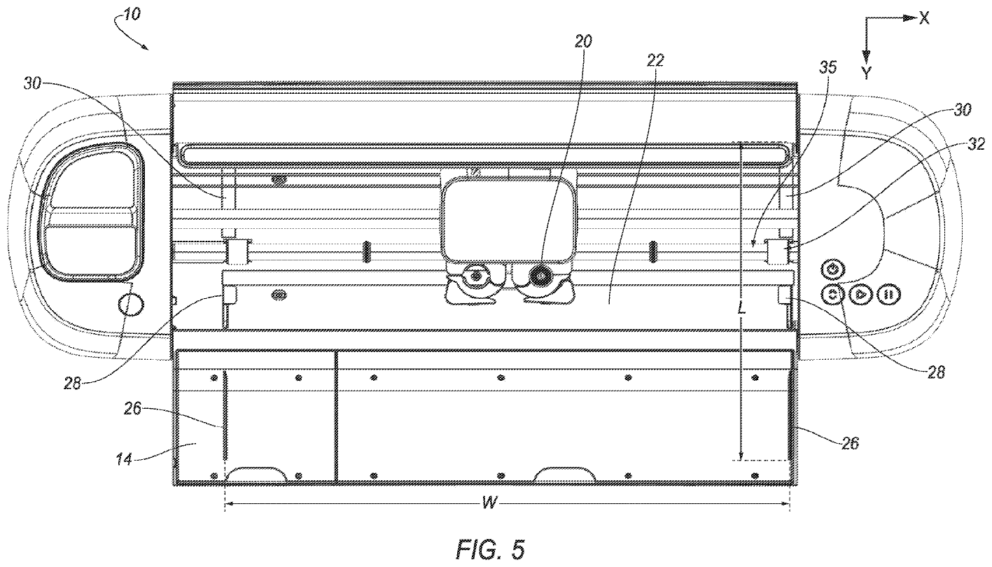

To further illustrate an exemplary implementation of how the first pair of workpiece guides 26, the optional second pair of workpiece guides 28, and the optional third pair of workpiece guides 30 work in concert in order to align the workpiece 36 fed into the cutting machine 10, with reference to FIG. 5, a top view of an exemplary implementation of the cutting machine 10 is shown. As seen at FIG. 5, the first pair of workpiece guides 26 are disposed or arranged forwardly of or upstream of the tool 20, whereas the third pair of workpiece guides 30 are disposed or arranged rearwardly of or downstream of the tool 20, while the second pair of workpiece guides 28 are arranged between or intermediately (or generally at or near the position of the tool 20 in the Y-direction) with respect to both of the first pair of workpiece guides 26 and the third pair of workpiece guides 30. Other exemplary implementations of the cutting machine 10 may include more than or less than the three workpiece guides 26, 28, 30 that are shown in the exemplary implementation of the cutting machine 10 of FIG. 5; furthermore, each set of the three workpiece guides 26, 28, 30 may be disposed or arranged at other positions, either closer to one another or further apart than that shown at FIG. 5.

Functionally, the first pair of workpiece guides 26, the optional second pair of workpiece guides 28, and the optional third pair of workpiece guides 30 effectively contribute to automatic alignment of the workpiece 36 (that is non-rigid, flexible, rollable, or the like) as a result of the workpiece 36 not being defined to have a rigid quality like conventional workpiece support mats. Accordingly, the first, second, and third pairs of workpiece guides 26, 28, 30 are sufficiently spaced far enough longitudinally (in the Y-direction) with respect to a predetermined width of the workpiece 36 that is to be guided through the cutting machine 10. For example, a length L (see, e.g., FIG. 5), is the longitudinal moment arm provided by one or more of the first, second, and third pairs of workpiece guides 26, 28, 30 for rotating/realigning a width W (see, e.g., FIG. 5) of the workpiece 36 being fed through the cutting machine 10. The longer the moment arm (i.e., the length L of FIG. 5) provided, the automatic alignment and realignment of the workpiece 36 will be more effective. However, the longitudinal distance in the Y-direction that is available for one or more of the first, second, and third pairs of workpiece guides 26, 28, 30 is limited by the size of cutting machine 10. In one aspect, as noted above, an exemplary arrangement of the first pair of workpiece guides 26 disposed on the upper surface of the door 14 or extendable working surface 22 as described herein increases the available moment arm of one or more of the first, second, and third pairs of workpiece guides 26, 28, 30 extending longitudinally in the Y-direction.

Along these lines, in some configurations, in order to achieve the function of automatic alignment of a workpiece 36 as noted above, in one or more embodiments, the total length L along which one, some, or all of the first, second, and third pairs of workpiece guides 26, 28, 30 extend longitudinally on the working surface 22 may be at least about 30% of the width W between one, some, or all of the first, second, and third pairs of workpiece guides 26, 28, 30 (or the approximate width W of the workpiece material layer 38 that is to be cut while being supported by the workpiece support material layer 40). In some configurations, the total length L along which some, or all of the first, second, and third pairs of workpiece guides 26, 28, 30 extend longitudinally on the working surface 22 is at least about 40% or at least about 50% of the width W between one, some, or all of the first, second, and third pairs of workpiece guides 26, 28, 30. In other configurations, the total length L along which one, some, or all of the first, second, and third pairs of workpiece guides 26, 28, 30 extend longitudinally on the working surface 22 is at least about 55% of the width W between one, some, or all of the first, second, and third pairs of workpiece guides 26, 28, 30. In yet other configurations, the total length L of one, some, or all of the first, second, and third pairs of workpiece guides 26, 28, 30 that is/are disposed longitudinally on the working surface 22 is at least about 60% of the width W between one, some, or all of the first, second, and third pairs of workpiece guides 26, 28, 30.

Furthermore, in some configurations, one, some, or all of the first, second, and third pairs of workpiece guides 26, 28, 30 may be one, or a combination, of removable, retractable, and movable in order to accommodate situations when one or both of the workpiece material layer 38 and the workpiece support material layer 40 is/are wider than the width W such that the workpiece 36 can be fed into the cutting machine 10. Such exemplary configurations enable the cutting machine 10 to be compatible with other non-standard dimensions of workpieces 36 and cutting mats, or, for example, when automatic alignment is not utilized and also to guide workpieces 36 defined by any number of widths.

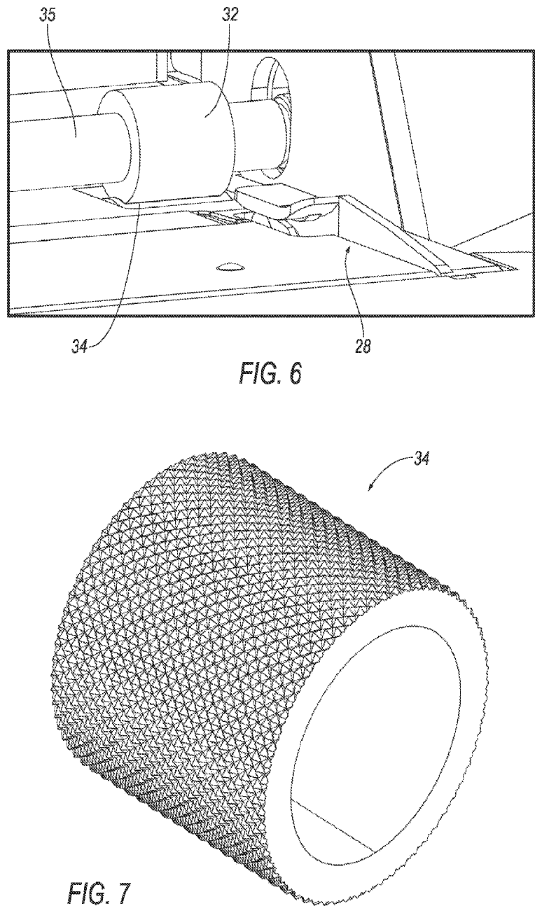

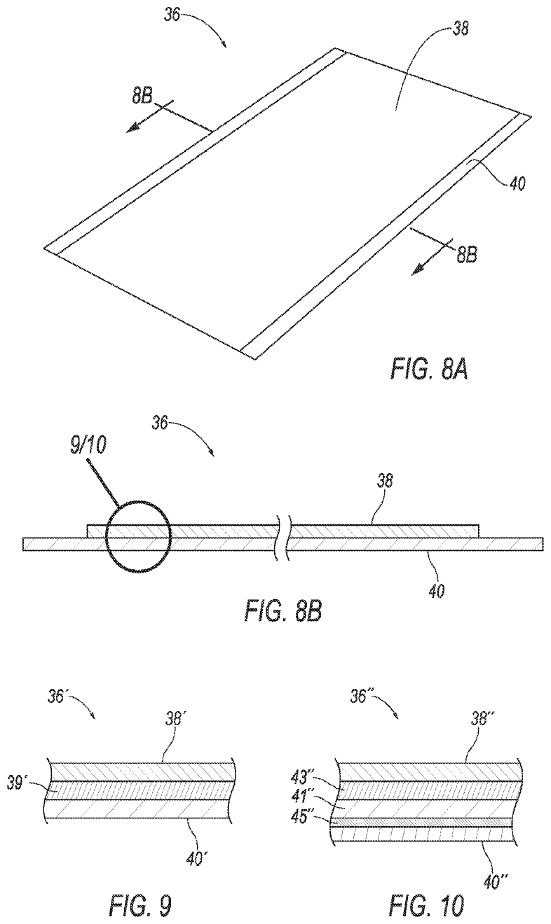

Referring to FIG. 6, a portion of the exemplary roller system 18 of the cutting machine 10 is shown. The roller assembly 18 is configured to feed the workpiece 36 backward-and-forward in the Y-direction through the cutting machine 10. In some instances, the roller assembly 18 includes upper roller 32 and lower roller 34, which are biased towards each other by a spring or other biasing mechanism (not shown). The upper roller 32 may be rigidly secured to an upper roller bar 35, and the lower roller 34 may be rigidly secured to a lower roller bar (not shown). Alternatively, one or both of the upper roller 32 and the lower roller 34 may not be respectively fixed to a roller bar but otherwise fixed relative to one another as shown. As seen at FIG. 6, in some configurations, the lower roller 34 may be driven by a motor (not shown) while the upper roller 32 is passive (i.e., the upper roller is not driven by a motor). However, in one or more embodiments, the upper roller 32 or both of the upper roller 32 and the lower roller 34 may be actively driven by a motor (not shown). In embodiments where only one of the upper roller 32 or the lower roller 34 is actively driven by, for example, a motor, the other of the upper roller 32 and the lower roller 34 is rotated due to the biasing of the upper roll 32 and the lower roller 34 together. In some configurations, the upper roller 32 and the lower roller 34 are biased together with a large enough force to grip and actuate the workpiece 36 passing between the upper roller 32 and the lower roller 34 without slipping but with a small enough force to allow the workpiece 36 to pass there-between after being loaded into the cutting machine 10.

The material(s) and geometry of the upper roller 32 and the lower roller 34 at least partially dictate the biasing force provided by the upper roller 32 and the lower roller 34. For example, in general, the force provided by the upper roller 32 and the lower roller 34 acts as the normal force component of the friction between the workpiece 36 and the upper and lower rollers 32, 34; thus, the coefficient of friction of each of the upper roller 32 and the lower roller 34 determines the force necessary for precise and consistent actuation of the workpiece 36 (i.e., the higher the coefficient of friction of the lower roller 34 when the lower roller 34 is driven, for example, the lower the biasing force necessary to create sufficient friction with the workpiece 36 and vice versa).

In addition, the higher the friction between upper roller 32 and the lower roller 34 and the workpiece 36, the less likely it will be that the workpiece 36 erroneously slips between the upper roller 32 and the lower roller 34. However, as noted above with reference to the exemplary configurations of the first, second, and third pairs of workpiece guides 26, 28, 30 located within cutting machine 10, as the workpiece 36 could be potentially misaligned within the cutting machine 10 (i.e., either when initially fed between the upper roller 32 and the lower roller 34 or during cutting), one or more of the first, second, and third pairs of workpiece guides 26, 28, 30 function as “bumpers” to force the workpiece 36 back-and-forth in the X-direction and into alignment as the workpiece 36 is actuated forward-and-backward in the Y-direction. Accordingly, for the most effective automatic alignment of the workpiece 36 in the cutting machine 10, when the workpiece 36 is pinched between the upper roller 32 and the lower roller 34, the workpiece 36 is preferably able to travel back and forth laterally in the X-direction as the roller assembly 18 draws the workpiece 36 forward-and-backward in the Y-direction between the upper roller 32 and the lower roller 34. Accordingly, the lateral travel of the workpiece 36 between the upper roller 32 and the lower roller 34, while small enough to not negatively affect the accuracy of a certain cut or operation of the tool 20, allows one or more of the first, second, and third pairs of workpiece guides 26, 28, 30 to automatically maintain good material alignment.

In some configurations, the combination of the biasing force between the upper roller 32 and the lower roller 34 and the material(s) defining each of the upper roller 32 and the lower roller 34, including coefficients of friction thereof, may be balanced such that: 1) the coefficient of friction between the upper roller 32 and the lower roller 34 and the material are small enough (or that the upper roller 32 and the lower roller 34 are “slick” enough) to allow lateral movement (in the X-direction) of the workpiece 36 between the upper roller 32 and the lower roller 34 under the given biasing force; and 2) the biasing force creates enough friction to maintain precise actuation of the workpiece 36, without slippage, in the Y-direction.

In other configurations, the roller assembly 18 may include an upper roller 32 made of polytetrafluoroethylene (PTFE)-filled polycarbonate material having a static coefficient of friction against a workpiece 36 being actuated of less than 1 (e.g., in some configurations, the average coefficient of friction of the upper roller 32 may be between about 0.05 and 0.50 according to the ASTM D1984 friction test). In other configurations, the roller assembly 18 may include a biasing force between the upper roller 32 and the lower roller 34 of at least about 10 kg-f. In yet other configurations, the roller assembly 18 may include a biasing force between the upper roller 32 and the lower roller 34 between about 10 kg-f (+/−10%) and 14 kg-f (+/−10%). In further configurations, the roller assembly 18 may include a biasing force between the upper roller 32 and the lower roller 34 more than 14 kg-f.

Also, for example, in some configurations, the average coefficient of friction of the upper roller 32 is between about 0.10 and 0.26 according to the ASTM D1984 friction test. In some instances, the average coefficient of friction of the upper roller 32 is about 0.18 according to the ASTM D1984 friction test. In some instances, the roller assembly 18 may include a biasing force between the upper roller 32 and the lower roller 34 of at least about 10 kg-f. In other instances, the roller assembly 18 may include a biasing force between the upper roller 32 and the lower roller 34 between about 10 kg-f and 14 kg-f. In yet other instances, the roller assembly 18 may include a biasing force between the upper roller 32 and the lower roller 34 more than 14 kg-f. In some embodiments, similar materials having similar properties may also be employed, such as other hard plastics with similarly low static coefficients of friction and so forth. For example, in an exemplary configuration, the upper roller 32 (or either the upper roller 32 and the lower roller 34, if passive) may be formed of polycarbonate, TEFLON®, or a composite polycarbonate-TEFLON® material as noted above.

In some configurations, if a material defining one or more of the upper roller 32 and the lower roller 34 are defined by a softer, higher friction material, and, thus, a lower force, the lower roller 34 may be defined by a needle-like surface geometry. The needle-like geometry may provide a gripping characteristic that reduces slippage of the workpiece 36 between the upper roller 32 and the lower roller 34.

Referring to FIG. 7, a perspective view of an exemplary lower roller 34 used in the roller assembly 18 is shown. The lower roller 34 of FIG. 7 is robust enough to withstand the higher forces (e.g., 10 kg-f or more) while maintaining a good grip on the workpiece 36. The lower roller 34 may be defined by a generally cylindrical shape and further includes a textured surface having a plurality of robust, square pyramid-shaped protrusions; such protrusions may be manufactured/formed by milling, lathing, or using other manufacturing methods. One or more other exemplary protrusions shapes may be incorporated into the design of the lower roller 34. In general, the lower roller 34 may include any desirable protrusion surface geometry that provides geometric features that improve gripping with the workpiece 36 while withstanding biasing forces from the opposing configuration of the upper roller 32 and the lower roller 34 of 10 kg-f (+/−10%) or more without breaking with repeated use.

In other configurations, the upper roller 32 may be formed (e.g., milled) in a substantially similar manner as described above to define protrusions like that of the lower roller 34 while the lower roller 34 is formed from a slick plastic material and operates in a passive manner, so long as the passive roller (e.g., the lower roller 34) includes the slick material described above and the actively driven roller (e.g., the upper roller 32) includes the higher traction, contoured surface geometry noted above, without departing from the functionalities of the roller assembly 18 described herein.

Furthermore, in other configurations, the cutting machine 10 may include more rollers than the upper roller 32 and the lower roller 34 extending laterally across upper roller bar 35 and the lower roller bar (e.g., some configurations of the cutting machine 10 may include three lower rollers and three upper rollers, four lower rollers and four upper rollers, or more). In order to ensure the best automatic alignment of the workpiece 36 fed through the cutting machine 10, however, multiple upper rollers 32 and lower rollers 34 may be defined by the same (or close to the same) diameter. For example, in at least one exemplary configuration, the diameter of each of a set of multiple lower rollers 34 may be configured to be about plus-or-minus about 5-microns of one another.

With reference to FIG. 8A, a perspective view of an exemplary workpiece 36 that is configured for use with the cutting machine 10 is shown. The workpiece 36 may include an upper layer defining the workpiece material layer 38 and a lower backing layer defining the workpiece support material layer 40. In some configurations, the tool 20 of the cutting machine 10 may be configured to impinge upon the workpiece material layer 38 but not the workpiece support material layer 40. For example, in some instances, where the tool 20 is a cutting blade, the cutting tool 20 will cut through the workpiece material layer 38 but not the workpiece support material layer 40. More details regarding the material properties and dimensions (including, e.g., a thickness) of the various layers of the workpiece 36 are described in the following disclosure, but, in general, the workpiece support material layer 40 may be configured to withstand the impinging force of the cutting tool 20 or other tools 20 while the workpiece material layer 38 may be a peelable vinyl or other material that may be configured to be penetrated by the cutting tool 20, a scoring tool, or other tools, and subsequently removed from the workpiece support material layer 40 after being deformed by the tool 20. In addition, in some instances, the workpiece support material layer 40 may be more rigid than the workpiece material layer 38 in order to promote automatic alignment of the workpiece 36 as the workpiece 36 is guided by material one or more of the first, second, and third pairs of workpiece guides 26, 28, 30 during use as described above.

With reference to FIG. 16B, in some configurations, the workpiece material layer 38 may be narrower than the workpiece support material layer 40 such that side portions of the workpiece support material layer 40 extend beyond the workpiece material layer 38 on either edge of the workpiece 36. In such exemplary configurations, the workpiece 36 is configured to be fed into the cutting machine 10 so that side portions of the workpiece support material layer 40 that extend laterally beyond the workpiece material layer 38, as shown at FIGS. 16 and 16B, are the portions of the workpiece 36 that are pinched between the upper roller 32 and the lower roller 34 of the roller assembly 18; in this way, the workpiece material layer 38 is not contacted by the upper roller 32 and the lower roller 34 and is less prone to separating or otherwise bunching, tunneling, or slipping from the workpiece support material layer 40 as side edges of the workpiece 36 contact one or more of the first, second, and third pairs of workpiece guides 26, 28, 30, and/or the upper roller 32 and the lower roller 34 during use. With reference to FIG. 8B, a cross-sectional view of the workpiece 36 is shown whereby the workpiece support material layer 40 extends laterally beyond the workpiece material layer 38 on either end.

In some configurations, the width of the workpiece support material layer 40 is the same as the workpiece material layer 38 such that no portions of the workpiece support material layer 40 extends beyond the workpiece material layer 38. In such exemplary configurations of the workpiece 36, the workpiece material layer 38 may be pinched between the upper roller 32 and the lower roller 34 when the workpiece 36 is fed into the cutting machine 10; however, in such configurations, the workpiece material layer 38 may be adhered securely enough to the workpiece support material layer 40 so that the workpiece material layer 38 is not negatively affected by forces from the upper roller 32 and the lower roller 34 or one or more of the first, second, and third pairs of workpiece guides 26, 28, 30.

With reference to FIG. 9, a cross-sectional view of an exemplary workpiece 36′ is shown. As seen at FIG. 9, an exemplary workpiece material layer 38′ may be removably secured to an exemplary workpiece support material layer 40′ by an acrylic release adhesive layer 39′. Furthermore, in some configurations, the workpiece support material layer 40′ may be comprised of polyethylene terephthalate (PET); in some instances, the workpiece support material layer 40′ may be about 0.175 mm thick. In a substantially similar manner as noted above, the workpiece support material layer 40′ may be configured to withstand forces from the tool 20 without being penetrated; as such, the workpiece support material layer 40′ may generally form a substantial portion of the total thickness of the workpiece 36′. For example, in some configurations, the workpiece support material layer 40′ may be at least about 30% of the total thickness of the workpiece 36′. In other configurations, the workpiece support material layer 40′ may be at least about 35% of the total thickness of the workpiece 36′. In yet other configurations, the workpiece support material layer 40′ may be at least about 40% of the total thickness of the workpiece 36′.

Referring to FIG. 10, a cross-sectional view of another exemplary of a workpiece 36″ is shown. As seen at FIG. 10, an exemplary workpiece material layer 38″ is releasably secured to an exemplary multi-layered workpiece support material layer 40″, which may include an intermediate PET liner layer 41″ that may be about 0.15 um thick and a silicone release adhesive layer 43″. In other configurations, the intermediate PET liner layer 41″ may be secured to a 0.025 mm thick PET workpiece support material layer 40″ by a Sum print adhesive layer 45″. In some configurations, the workpiece support material layer 40″ may include a polypropylene (PP) or PET film having a thickness approximately equal to about 0.12 mm.

Other combinations of layers, including various materials, thicknesses, and arrangement may also be formed to be used as a workpiece that is configured for use in the cutting machine 10. Accordingly, the exemplary workpieces 36, 36′, 36″ described herein and other embodiments thereof may be configured to be rigid enough to be automatically guided and aligned within the cutting machine 10 described herein without the use of conventional, relatively rigid, heavy-duty cutting mats. However, one skilled in the art will appreciate that the materials, thicknesses, and arrangement of layers of defining the exemplary workpieces 36, 36′, 36″ described herein are given only as non-limiting examples of appropriate materials. Other combinations, material layers, and thicknesses thereof, can also be used with the cutting machine 10. In general, a total thickness of the exemplary workpieces 36, 36′, 36″ may vary between about 0.15 mm to about 0.40 mm or thicker.

The exemplary workpieces 36′, 36″ shown in FIGS. 9 and 10 are examples of workpieces that are configured for use that results in auto-alignment within the cutting machine 10, but also inexpensive enough to produce at a large scale with a low enough consumer price point to be repeatably purchased and used as a consumable. In addition, the exemplary workpieces 36, 36′, 36″ of the present disclosure are flexible enough to be rolled or otherwise efficiently packaged in large quantities without plastically or permanently deformation (as opposed to conventional, rigid, heavy-duty, and expensive cutting mats) that are made with more expensive, thicker materials. Because of the associated expense of conventional, rigid, heavy duty cutting mats, such cutting mats are meant to be reused, thus limiting cutting area and the length as described above that are associated with the exemplary “consumable” workpieces 36, 36′, 36″. In contrast, the exemplary workpieces 36, 36′, 36″ of the present disclosure can be inexpensively sold in large quantities and cut as a consumable product, thus enabling cost-effective, limitless cutting lengths for end users.

Although the following disclosure is directed to the exemplary workpiece 36, the following disclosure may also apply to the exemplary workpieces 36′, 36″. The material defining the workpiece material layer 38 may vary depending on the needs or wants of the end user. For example, some materials defining the workpiece material layer 38 may be opaque, whereas other materials defining the workpiece material layer 38 may be transparent, and yet other materials defining the workpiece material layer 38 may be semi-transparent, or a combination thereof. In at least some configurations of the cutting machine 10 described herein, a material sensor (not shown) may be disposed above working surface 22, which may detect the type and/or color of the material defining the workpiece material layer 38 being fed though the cutting machine 10. In some configurations, such a material sensor may be disposed rearwardly of the tool 20. In other configurations, such a sensor may be disposed elsewhere within the cutting machine 10. In order to detect a range of materials defining the workpiece material layer 38, including transparent or semi-transparent materials defining the workpiece material layer 38, the material sensor may be disposed at an angle with respect to the working surface 22. The specific angle of the material sensor may vary but is such that a wide range of transparencies can be detected by the sensor. In some examples, transparent materials defining the workpiece material layer 38 are more difficult to detect with the sensor aligned normal to the material defining the workpiece material layer 38 than opaque materials. However, the angle of the sensor and/or a light source detected by the sensor in relation to the material defining the workpiece material layer 38 being detected is optimized based on a range of transparent material properties, such as angle of incidence, to more effectively detect transparent and semi-transparent materials defining the workpiece material layer 38.

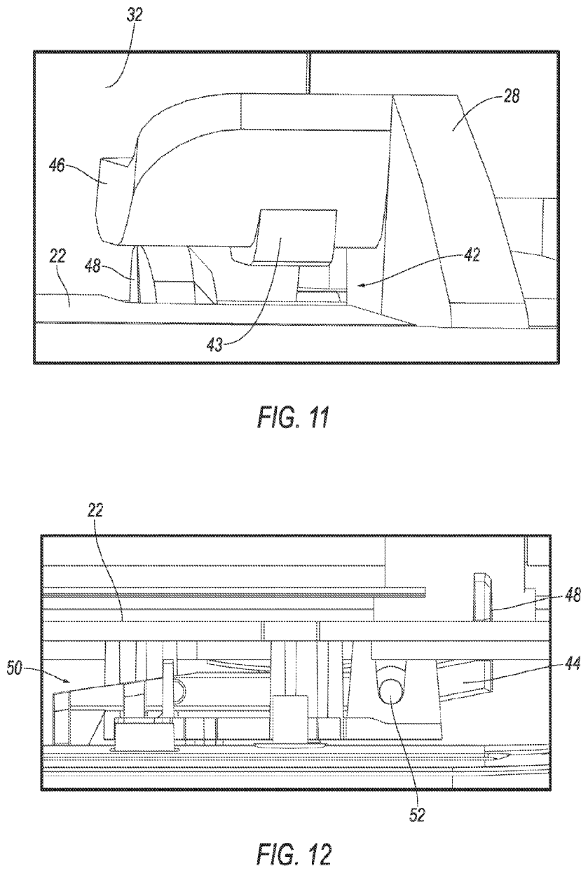

In addition to the various embodiments of the first, second, and third pairs of workpiece guides 26, 28, 30, the roller assembly 18, and the workpiece 36 described herein, other features of the cutting machine 10 may be utilized to enhance matless cutting and improve user experiences. For example, with reference to FIG. 11, an exemplary material sensing mechanism 42 is shown disposed in front of the upper roller 32 and adjacent to a workpiece guide of the second pair of workpiece guides 28. The sensing mechanism 42 may also be disposed elsewhere in one or more other embodiments, such as, for example, next to the upper roller 32 and the workpiece guide of the second pair of workpiece guides 28 or elsewhere within the cutting machine 10. The sensing mechanism 42 may function in a manner that detects the presence and thickness of the workpiece 36 that is fed into the cutting machine 10 upon or over the working surface 22.

With reference to FIG. 11, a first end portion 48 of a rocker arm 44 is shown extending upwardly through an opening in working surface 22. The first end portion 48 may be rounded in order to allow the workpiece 36 to be inserted between the first end portion 48 and an upper wall 46 of the workpiece guide of the second pair of workpiece guides 28, thereby forcing the rocker arm 44 downward (e.g., Z-direction). With reference to FIG. 12, the rocker arm 44 is shown disposed below the working surface 22. The rocker arm 44 may be rotationally connected to a housing at a pivot point 52 such that when the workpiece 36 is inserted into the cutting machine 10 as described above, the first end portion 48 of the rocker arm 44 is pushed downwardly and then the second end portion 50 of the rocker arm 44 is rotated up. The second end portion 50 interfaces with a sensor near the second end portion 50, which detects the movement and/or presence of the second end portion 50 relative to the sensor, thus detecting when the workpiece 36 has been fed into the cutting machine 10 as well as the thickness of the workpiece support material layer 40.

The upper wall 46 that extends horizontally from the second material guide 28 is advantageously arranged so as to keep the workpiece 36 from raising off the working surface 22 during use. In some configurations, the rocker arm 44 may be disposed within the X-Z plane. In this way, regardless of whether the workpiece 36 is actuated forward or backward in the Y-direction, any risk of friction lock against the upper wall 46 is mitigated because the horizontal component (in the X-direction) of the rotation of the first end 48 of the rocker arm 44 is perpendicular to the Y-direction of the workpiece 36 traveling between the first end 48 of the rocker arm 44 and the upper wall 46. In addition, the lateral disposition of the rocker arm 44 within the X-Z plane (e.g., for pivotal movement about an axis extending substantially (e.g., +/−10%) parallel to the Y-axis) allows for a thinner form factor of the cutting machine 10 in the Y-direction in general, as compared to a rocker arm 44 extending in the Y-Z plane (e.g., for pivotal movement about an axis extending substantially parallel to the X-axis).

Once the workpiece 36 is detected, the upper roller 32 and the lower roller 34 may be activated to auto-feed the workpiece 36 into the cutting machine 10. The upper roller 32 and the lower roller 34 or motor(s) (not shown) actuating one or both of the upper roller 32 and the lower roller 34 may also include one or more sensors (not shown) that detect resistance to rolling (e.g., if a user tries to pull the workpiece 36 out during an ongoing project, one or more of the upper roller 32 and the lower roller 34 may be activated in order to push the workpiece 36 out of the cutting machine 10).

In some configurations, the sensing mechanism 42 may include a rib 43 protruding downwardly from a lower surface of the upper wall 46. The rib 43 may functionally decrease the space between the upper wall 46 and the working surface 22, which allows for a shorter arm at the second end portion 50 of the rocker arm 44 that interfaces with the sensor. This allows for a smaller space provided for the sensor while maintaining a larger detecting range using easily moldable parts. In some configurations, the sensing mechanism 42 may be capable of detecting workpiece 36 ranging between about 0.18 mm thick to about 0.5 mm thick.

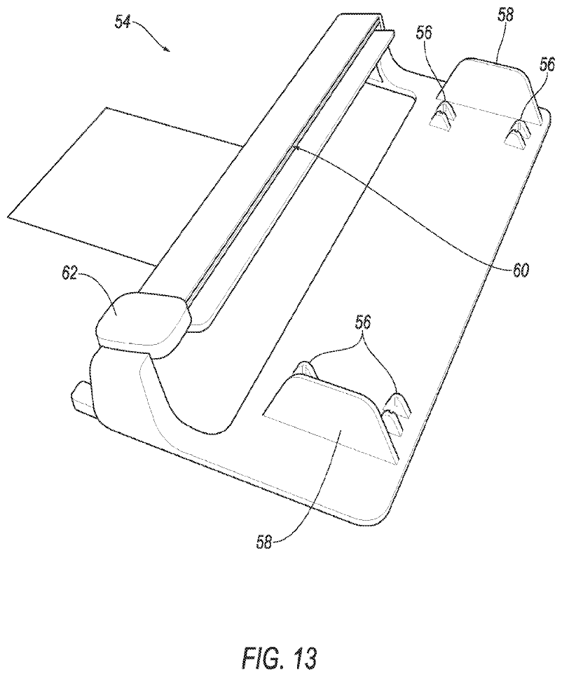

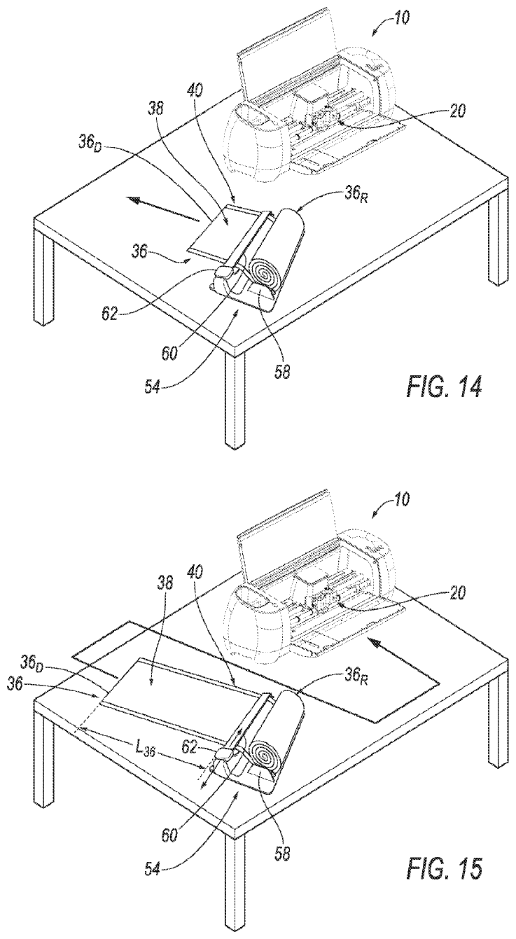

With reference to FIG. 13, other configurations of the cutting machine 10 may include a material roll holder 54. As noted above, the workpiece 36 may be configured to be flexible enough to be efficiently packaged and shipped, for example in a roll. A roll (see, e.g., 36R at FIGS. 14-17) of workpiece 36 allows large lengths of workpiece 36 to be stored in a small or reduced volume. However, long lengths of rolled workpiece 36 may be difficult to handle during cutting operations of the cutting machine 10. By incorporating or associating the roll holder 54 with the cutting machine 10, an end user can place a roll 36R of workpiece 36 to be cut near the cutting machine 10 between sidewalls 58 of the material roll holder 54 and on top of roll guides 56 of the material roll holder 54. With reference to FIGS. 14-15, the roll 36R of workpiece 36 can rotate in place on top of the roll guides 56 and between the sidewalls 58; furthermore, in some configurations, the roll 36R of workpiece 36 can rotate in place on top of the roll guides 56 and between the sidewalls 58 after a distal end 36D is disposed within the cutting machine 10 such that the upper roller 32 and the lower roller 34 of the cutting machine 10 pull or reel a portion of the length (see, e.g., L₃₆ at FIG. 15) of the roll 36R of workpiece 36 into the cutting machine 10. Accordingly, in some configurations, the reeled portion of the length L₃₆ of the workpiece 36 from the roll 36R of the workpiece 36 can be fed through a guide slot 60 of the material roll holder 54 in order to ensure horizontal alignment of the workpiece 36 with the working surface 22 of the cutting machine 10 as the workpiece 36 is reeled from the roll 36R of the workpiece 36 for subsequent feeding into the cutting machine 10 by the upper roller 32 and the lower roller 34. In other configurations, the roll holder 54 may also include a razor blade 62 or other cutting mechanism guided by an upper wall of the guide slot 60 that permits easy and convenient cutting of a reeled length L₃₆ of the workpiece 36 from the roll 36R of the workpiece 36 when a project is finished.

In yet other configurations of the roll holder 54, one or more damping mechanisms and/or springs (not shown) may be included in order to control a rate of rotation of the roll 36R of the workpiece 36 that is reeled from the roll holder 54 during use. Damping mechanisms may, for example, prevent the workpiece 36 that is reeled from the roll 36R of the workpiece 36 from over-rotation due to the inertia of the roll 36R of the workpiece 36 being further rotated even after one or both of the upper roller 32 and the lower roller 34 has/have stopped feeding a desired amount of reeled length L₃₆ the workpiece 36 from the roll 36R of the workpiece 36 into the cutting machine 10.

Conversely, spring loaded mechanisms may also function to oppose forces from the upper roller 32 and the lower roller 34 so that the roll 36R of the workpiece 36 extending from or being reeled from the roll holder 54 into the cutting machine 10 remains taut, particularly when the upper roller 32 and the lower roller 34 push the workpiece 36 back out toward the roll holder 54 during a cutting operation.

As noted above, each of the embodiments described in the detailed description above may include any of the features, options, and possibilities set out in the present disclosure figures, including those under the other independent embodiments, and may also include any combination of any of the features, options, and possibilities set out in the present disclosure and figures. Further examples consistent with the present teachings described herein are set out in the following numbered clauses:

Clause 1: An electronic cutting machine, comprising: a working surface configured to support a material sheet fed into the cutting machine during use; a door; and one or more sets of material guides extending upward from the working surface, wherein at least one set of the one or more sets of material guides extend upward from an upper surface of the door when the door is open, the upper surface of the open door forming at least a portion of the working surface.

Clause 2: The electronic cutting machine of clause 1, further comprising at least two sets of material guides, wherein at least one of the at least two sets of material guides is disposed rearward of a tool disposed within the cutting machine.

Clause 3: The electronic cutting machine of any of clauses 1 or 2, further comprising three separate sets of material cutting guides.

Clause 4: The electronic cutting machine of any of clauses 1 through 3, wherein a total length of the one or more sets of material guides extending longitudinally on the working surface is at least 30% of the lateral distance between opposing material guides of each set of material guides.

Clause 5: The electronic cutting machine of any of clauses 1 through 3, wherein a total length of the one or more sets of material guides extending longitudinally on the working surface is about 40% of the lateral distance between opposing material guides of each set of material guides.

Clause 6: An electronic cutting machine of any of the preceding clauses 1 through 5, comprising a roller system having a first roller and an opposing second roller, the upper and lower rollers biased together via a biasing force, wherein the first roller comprises a material having an average coefficient of static friction of less than 1, according to ASTM D1984.

Clause 7: The electronic cutting machine of clause 6, wherein the second roller comprises a textured surface forming a plurality of geometric protrusions.

Clause 8: The electronic cutting machine of any of clauses 6 through 7, wherein the biasing force is greater than about 10 k g-f.

Clause 9: The electronic cutting machine of any of clauses 6 through 8, wherein the first roller comprises polycarbonate having an average coefficient of static friction of between about 0.05 and 0.50 according to ASTM D1984.

Clause 10: The electronic cutting machine of any of clauses 6 through 9, wherein the biasing force is between about 10 kg-f and 14 kg-f.

Clause 11: An electronic cutting machine of any of the preceding clauses 1 through 10, comprising: a working surface disposed in a horizontal X-Y plane, the working surface configured to support a material sheet fed into the cutting machine during use; and a material sensing mechanism having a rocker arm disposed in the X-Z plane perpendicular to the X-Y plane in which the working surface is disposed.

Clause 12: The electronic cutting machine of clause 11, further comprising an upper wall extending horizontally in the X-Y plane from a material guide that extends vertically from the working surface in the Y-Z plane, the upper wall disposed above a first end of the rocker arm.

Clause 13: The electronic cutting machine of clause 12, further comprising a rib extending downward from a lower surface of the upper wall.

Clause 14: An electronic cutting machine kit, comprising: a material sheet having an upper layer and a lower backing layer; and an electronic cutting machine of any of the previous clauses 1 through 13 configured to automatically align and maintain alignment of the material sheet as the material sheet is fed through the cutting machine during use.

Clause 15: The electronic cutting machine kit of clause 14, wherein the lower backing layer of the material sheet is wider than the upper layer of the material sheet such that the lower backing layer extends beyond the upper layer at either edge of the material sheet.

Clause 16: The electronic cutting machine kit of any of clauses 14 through 15, wherein the lower backing layer of the material sheet is at least 35% of a total thickness of the material sheet.

Clause 17: The electronic cutting machine kit of any of clauses 14 through 16, wherein the material sheet is rigid enough to be aligned and realigned within the cutting machine without the use of a separate, more rigid cutting mat.

Clause 18: The electronic cutting machine kit of any of clauses 14 through 17, wherein the lower backing layer of the material sheet comprises at least two layers of material secured together via an adhesive layer.

Clause 19: The electronic cutting machine kit of any of clauses 14 through 18, wherein the material sheet is flexible enough to be packaged in a roll without plastically deforming the material sheet.

Clause 20: An electronic cutting machine, comprising: a working surface configured to support a workpiece; a door movable between an open position and a closed position and having an upper surface configured to support the workpiece in the open position, the upper surface disposed substantially parallel to the working surface; and a first material guide extending from the upper surface when the door is in the open position.

Clause 21: The electronic cutting machine of clause 20, further comprising: a second material guide extending from the working surface; and a tool coupled to the electronic cutting machine and disposed between the first material guide and the second material guide.

Clause 22: The electronic cutting machine of any of clauses 20 or 21, further comprising a third material guide extending from one of the working surface or the upper surface.

Clause 23: The electronic cutting machine of any of clauses 20 through 22, further comprising: a second material guide extending from the working surface, the first material guide and the second material guide collectively defining a total length in a Y-direction; and a third material guide extending from one of the working surface or the upper surface, the third material guide spaced from the first material guide or the second material guide by a distance in an X-direction, wherein the total length is at least 30% of the distance.

Clause 24: The electronic cutting machine of clause 23, wherein the total length is at least 40% of the distance.

Clause 25: An electronic cutting machine, comprising: a first roller having an outer surface formed at least in part from a material having an average coefficient of static friction of less than one; and a second roller opposing the first roller, at least one of the first roller or the second roller biased toward the other of the first roller or the second roller by a force.

Clause 26: The electronic cutting machine of clause 25, wherein the second roller comprises a textured surface including a plurality of protrusions.

Clause 27: The electronic cutting machine of any of clauses 25 through 26, wherein the force is greater than about 10 k g-f.

Clause 28: The electronic cutting machine of clause 27, wherein the material includes a polycarbonate having an average coefficient of static friction of between about 0.05 and 0.50.

Clause 29: The electronic cutting machine of clause 28, wherein the force is between about 10 kg-f and 14 kg-f.

Clause 30: An electronic cutting machine, comprising: a working surface disposed in a first plane and configured to support a workpiece; and a rocker arm disposed in a second plane disposed transverse to the first plane, the rocker arm configured to pivot about an axis extending substantially parallel to the first plane.

Clause 31: The electronic cutting machine of claim 30, further comprising a material guide extending from the working surface in a direction transverse to the first plane and the second plane, the material guide including an upper wall disposed at least partially above the rocker arm and extending in a third plane disposed substantially parallel to the first plane.

Clause 32: The electronic cutting machine of clause 31, further comprising a rib extending downward from a lower surface of the upper wall.

Clause 33: An electronic cutting machine kit, comprising: a workpiece having a workpiece material and a workpiece support material; and an electronic cutting machine configured to receive the workpiece, the electronic cutting machine including a plurality of guides configured to engage the workpiece support material and align the workpiece relative to the electronic cutting machine.

Clause 34: The electronic cutting machine kit of clause 33, wherein the workpiece support material forms a lower backing layer of the workpiece and defines a first width, and wherein the workpiece material forms an upper layer of the workpiece and defines a second width that is less than the first width.

Clause 35: The electronic cutting machine kit of any of clauses 33 through 34, wherein the workpiece support material is at least 35% of a total thickness of the workpiece.

Clause 36: The electronic cutting machine kit of any of clauses 33 through 35, wherein guides are configured to align the workpiece without the use of a cutting mat.

Clause 37: The electronic cutting machine kit of any of clauses 33 through 36, wherein the workpiece support material comprises a first layer of material, a second layer of material, and an adhesive material securing the first layer of material to the second layer of material.

Clause 38: The electronic cutting machine kit of any of clauses 33 through 37, wherein the workpiece forms a non-plastically deformed roll.

Clause 39: A method comprising: receiving a workpiece into an electronic cutting machine, the workpiece including a workpiece support material and a workpiece material, the workpiece support material forming a backing layer and defining a first width, the workpiece material forming an upper layer and defining a second width that is less than the first width; engaging the workpiece support material with at least one guide and at least one roller of the electronic cutting machine; and altering the workpiece material with the electronic cutting machine.

Clause 40: The method of clause 39, wherein the at least one guide and the at least one roller are spaced apart from the workpiece material.

Clause 41: The method of any of clauses 39 through 40, wherein engaging the workpiece support material with at least one roller includes engaging the workpiece support material with (i) a first roller disposed on a first side of the workpiece support material and (ii) a second roller disposed on a second side of the workpiece support material, wherein the first roller is spaced apart from the second roller by a first distance that is greater than the second width.

Clause 42: A workpiece comprising: a workpiece support material forming a backing layer and defining a first width and a first thickness; a workpiece material forming an upper layer and defining a second width and a second thickness, the second width being less than the first width, the second thickness being not more than 50% of the first thickness; and an adhesive securing the workpiece material to the workpiece support material.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An electronic cutting machine, comprising:
a working surface configured to support a workpiece;
a door movable between an open position and a closed position and having an upper surface configured to support the workpiece in the open position, the upper surface disposed substantially parallel to the working surface; and
a first material guide extending from the upper surface when the door is in the open position.

2. The electronic cutting machine of claim 1, further comprising:
a second material guide extending from the working surface; and
a tool coupled to the electronic cutting machine and disposed between the first material guide and the second material guide.

3. The electronic cutting machine of claim 1, further comprising a third material guide extending from one of the working surface or the upper surface.

4. The electronic cutting machine of claim 1, further comprising:
a second material guide extending from the working surface, the first material guide and the second material guide collectively defining a total length in a Y-direction; and
a third material guide extending from one of the working surface or the upper surface, the third material guide spaced from the first material guide or the second material guide by a distance in an X-direction, wherein the total length is at least 30% of the distance.

5. The electronic cutting machine of claim 4, wherein the total length is at least 40% of the distance.

6. An electronic cutting machine, comprising:
a first roller having an outer surface formed at least in part from a material having an average coefficient of static friction of less than one; and
a second roller opposing the first roller, at least one of the first roller or the second roller biased toward the other of the first roller or the second roller by a force.

7. The electronic cutting machine of claim 6, wherein the second roller comprises a textured surface including a plurality of protrusions.

8. The electronic cutting machine of claim 7, wherein the force is greater than about 10 kg-f.

9. The electronic cutting machine of claim 8, wherein the material includes a polycarbonate having an average coefficient of static friction of between about 0.05 and 0.50.

10. The electronic cutting machine of claim 9, wherein the force is between about 10 kg-f and 14 kg-f.

11. An electronic cutting machine, comprising:
a working surface disposed in a first plane and configured to support a workpiece; and
a rocker arm disposed in a second plane disposed transverse to the first plane, the rocker arm configured to pivot about an axis extending substantially parallel to the first plane.

12. The electronic cutting machine of claim 11, further comprising a material guide extending from the working surface in a direction transverse to the first plane and the second plane, the material guide including an upper wall disposed at least partially above the rocker arm and extending in a third plane disposed substantially parallel to the first plane.

13. The electronic cutting machine of claim 12, further comprising a rib extending downward from a lower surface of the upper wall.

14. An electronic cutting machine kit, comprising:
a workpiece having a workpiece material and a workpiece support material; and
an electronic cutting machine configured to receive the workpiece, the electronic cutting machine including a plurality of guides configured to engage the workpiece support material and align the workpiece relative to the electronic cutting machine.

15. The electronic cutting machine kit of claim 14, wherein the workpiece support material forms a lower backing layer of the workpiece and defines a first width, and wherein the workpiece material forms an upper layer of the workpiece and defines a second width that is less than the first width.

16. The electronic cutting machine kit of claim 14, wherein the workpiece support material is at least 35% of a total thickness of the workpiece.

17. The electronic cutting machine kit of claim 14, wherein the guides are configured to align the workpiece without the use of a cutting mat.

18. The electronic cutting machine kit of claim 14, wherein the workpiece support material comprises a first layer of material, a second layer of material, and an adhesive material securing the first layer of material to the second layer of material.

19. The electronic cutting machine kit of claim 14, wherein the workpiece forms a non-plastically deformed roll.

20. A method comprising:
receiving a workpiece into an electronic cutting machine, the workpiece including a workpiece support material and a workpiece material, the workpiece support material forming a backing layer and defining a first width, the workpiece material forming an upper layer and defining a second width that is less than the first width;
engaging the workpiece support material with at least one guide and at least one roller of the electronic cutting machine; and
altering the workpiece material with the electronic cutting machine.

21. The method of claim 20, wherein the at least one guide and the at least one roller are spaced apart from the workpiece material.

22. The method of claim 20, wherein engaging the workpiece support material with at least one roller includes engaging the workpiece support material with (i) a first roller disposed on a first side of the workpiece support material and (ii) a second roller disposed on a second side of the workpiece support material, wherein the first roller is spaced apart from the second roller by a first distance that is greater than the second width.

23. A workpiece comprising:
a workpiece support material forming a backing layer and defining a first width and a first thickness;
a workpiece material forming an upper layer and defining a second width and a second thickness, the second width being less than the first width, the second thickness being not more than 50% of the first thickness; and
an adhesive securing the workpiece material to the workpiece support material.
